(19) United States
(12) Patent Application Publication
(10) Pub. No.: US 2015/0058626 A1
(43) Pub. Date: Feb. 26, 2015

(54) Programming Method, Battery with an Arrangement for Carrying out the Programming Method and a Motor Vehicle Comprising said Type of Battery

(71) Applicants: Robert Bosch GmbH, Stuttgart (DE); Samsung SDI Co., Ltd., Yongin-si, Gyeonggi-do (KR)

(72) Inventors: Andre Boehm, Kornwestheim (DE); Christoph Brochhaus, Aachen (DE)

(21) Appl. No.: 14/388,801

(22) PCT Filed: Jan. 28, 2013
(86) PCT No.: PCT/EP2013/051570

§ 371 Date: Sep. 26, 2014

(30) Foreign Application Priority Data
Mar. 28, 2012 (DE) 10 2012 205 010.8

(51) Int. Cl. H04L 9/32; G06F 21/30; H04L 29/08

(52) U.S. Cl. CPC H04L 9/3226; H04L 67/12; G06F 21/30
USPC 713/168; 726/2

(57) ABSTRACT

A programming method includes programming of at least two second data processing modules using a first data processing module. The programming method further includes providing first authentication information messages to the first data processing module, wherein each of the first authentication information messages is generated from each of at least two second data processing modules. The programming method further includes generating second authentication information messages, wherein each of the second authentication information messages is generated from each of the first authentication information messages, wherein the second authentication information messages are transmitted jointly from the first data processing module using one-time sending to the at least two second data processing modules.

The present invention relates to a programming method, a battery combined with an arrangement for carrying out the programming method and a motor vehicle comprising such a battery which can be used, in particular, for secure parallel programming of control devices.

### PRIOR ART

In the flash-programming of control devices, a so-called challenge-response method is often used as security in order to prevent unauthorized persons from obtaining writing access to the flash of a control device in order to possibly infiltrate their own code there:
a data processing means, e.g. a so-called tester, requests from a control device to be programmed a so-called seed x, e.g. a random number of n bytes;
the control device to be programmed sends the seed x to the tester,
the tester calculates from the seed x a so-called key by means of a function f(x),
the control device to be programmed also calculates from the seed the associated key by means of f(x), the function f(x) on the tester and on the control device to be programmed being identical,
the tester sends the key to the control device to be programmed,
if the key sent to the control device to be programmed matches the key calculated on the control device to be programmed, the tester is authorized to reprogram the control device.

The control device to be programmed unblocks the write access to its flash memory.

In battery packs, for example for electric cars, a central control device 102 is usually used which co-ordinates a particular number n of subordinate control devices 104-1, 104-2, . . . , 104-n. The subordinate control devices 104-1, 104-2, . . . , 104-n acquire measurement data such as cell voltage and/or temperature etc. close to the battery cells 106-1, 106-2, . . . , 106-n. The central control device 102 and the subordinate control devices 104-1, 104-2, . . . , 104-n are connected by a communication bus 108, for example a CAN bus.

When flash-programming a number of control devices, the above-mentioned method must be performed for each control device (compare FIG. 2). Secure parallel programming 202 of a number of similar subordinate control devices (destination devices) 104-1, 104-2, . . . , 104-n with the same program code is not possible without previous negotiation 204-1, 204-2, . . . , 204-n of seed/key with each destination device 104-1, 104-2, . . . , 104-n.

If in a link-up of control devices, there are many similar control devices which run with the same software such as is the case, for example, in battery management systems with a main control device and many subordinate sensor control devices, no method is known from the prior art which implements parallel programming and simultaneous securing of the flash process against unauthorized access.

From European patent specification EP 1 055 983 B1 a control device comprising at least two control units is already known where data for programming the at least two control units are transmitted simultaneously to the at least two control units. However, the programming is not secured in the method according to EP 1 055 983 B1.

A method for programming a microcontroller is known from the publication DE 199 50 159 A1. This solution, too, proposes unsecured programming of a memory area of the microcontroller in which the payload data provided for the programming are transferred from a buffer memory simultaneously into the memory areas of the microcontroller to be programmed.

### DISCLOSURE OF THE INVENTION

A particular advantage of the invention consists in that the serial programming of a multiplicity of destination control devices is replaced by parallel secured programming which leads to a considerable acceleration of the programming process by approximately the factor “number of control devices to be programmed”. This is achieved in that, according to the invention, at least two second data processing means are programmed by a first data processing means and wherein a first authentication information message is in each case sent to the first data processing means by the at least two second data processing means. The first data processing means can be, for example, a central control device, particularly a main control device of a battery management system of a motor vehicle. The at least two second data processing means can be, for example, control devices which are subordinate to the first data processing means. In a preferred embodiment, it is provided that the at least two second data processing means are sensor control devices of a battery management system. By means of such sensor control devices, measurement data of battery cells can be acquired, for example.

The first authentication information messages sent by the at least two second data processing means are preferably a public key of an asymmetric encryption process, for example a seed which is utilized in a challenge-response method.

A second authentication information message is generated in each case from the first authentication information messages preferably by the first data processing means and transmitted to the at least two second data processing means. By each of the at least two second data processing means, the following is carried out:

verification of the second authentication information message which was generated from the first authentication information message sent by the respective second data processing means, and programming of the respective second data processing means in dependence on the result of the verification.

According to the invention, it is also provided that the at least two second authentication information messages are transmitted jointly from the first data processing means by one-time sending to the at least two second data processing means. The at least two second authentication information messages are transmitted preferably simultaneously by the first data processing means in one data stream to the at least two second data processing means. In a preferred embodiment, it is provided that the transmission is effected in accordance with a broadcast method.

In another preferred embodiment, it is provided that the first data processing means provides a joint request to the at least two second data processing means, preferably simultaneously in a broadcast method, in order to request the first authentication information messages. As an alternative, this request can also be made serially to each individual one of the at least two second data processing means in an individualized data stream.

A further preferred embodiment provides that data for programming the at least two second data processing means are transmitted together with the at least two second authentication information messages by means of the one-time sending.

Another preferred embodiment provides that the at least two first authentication information messages are requested once by the first data processing means from the at least two second data processing means. The first authentication information messages received by the at least two second data processing means are stored permanently preferably in a memory area which can be accessed by the first data processing means. This has the advantage that the first authentication information messages do not need to be requested again every time the at least two second data processing means are to be programmed. Instead, the first authentication information messages stored permanently are utilized by the first data processing means for generating the at least two second authentication information messages when the at least two second data processing means are to be reprogrammed. In this manner, a multiplicity of (re)programming operations of the at least two second data processing means can be carried out without first requesting the first authentication information messages explicitly from the at least two second data processing means.

A further preferred embodiment provides that at least a part, preferably all, of the at least two second authentication information messages are generated by encrypting an identifier of the data for the programming. The identifier can be a checksum over the data for the programming. The first authentication information messages are preferably used as (public) key. It is found to be advantageous if the identifier is encrypted with all at least two second authentication information messages. In a preferred embodiment it is provided that at least a part of the at least two second data processing means has, and sends to the first data processing means, different first authentication information messages. The at least two second authentication information messages generated are transmitted to the at least two second data processing means. After reception of the at least two second authentication information messages, the at least two second data processing means decrypt the received second authentication information messages with a (private) key. If one of the received second authentication information messages, particularly the identifier of the data for the programming, can be verified, it means that the programming of the respective second data processing means is permissible and the programming will be executed.

It is found to be advantageous if the at least two second data processing means are similar or identical data processing means and/or the data for the programming for each of the at least two second data processing means are the same data.

A further aspect of the invention relates to a battery which is combined with an arrangement, wherein the arrangement comprises a first data processing means and at least two second data processing means and wherein the arrangement is configured in such a manner that a programming method can be carried out, the first data processing means programming the at least two second data processing means and the at least two second data processing means sending in each case a first authentication information message to the first data processing means, a second authentication information message being generated in each case from the first authentication information messages and being transmitted to the at least two second data processing means and, after verification of the second authentication information messages by in each case the at least two second data processing means, the at least two second data processing means being programmed. According to the invention, it is provided in this context that the at least two second authentication information messages are transmitted jointly by the first data processing means by one-time sending to the at least two second data processing means. The battery is preferably a lithium ion battery or the battery comprises electrochemical cells which are configured as lithium ion battery cells. The arrangement can be, for example, a battery management system or the arrangement can be integrated in a battery management system.

Another aspect of the invention relates to a motor vehicle with an electric drive motor for driving the motor vehicle and a battery, connected or connectable to the electric drive motor, according to the aspect of the invention described in the preceding paragraph. However, the battery is not restricted to such an application but can also be used in other electrical systems.

An important aspect of the invention consists in that only a single data stream is sent in the broadcast method from the control device or tester to subordinate, preferably similar control devices such as, for example, sensor control devices used in electric cars. All destination control devices are programmed in parallel, the method according to the invention ensuring that no unauthorized person can infiltrate their own program code into the control devices, e.g. for tuning components in that an encrypted checksum is transmitted. After verifying the checksum in the destination control device, the latter marks the software as “authenticated” and executes the new software. When a wrong checksum is transferred, e.g. by an unauthorized third party, the software is not executed in the destination control device. Without knowledge of the encryption method, an unauthorized third party who attempts to program their own software into the destination control device can thus not generate a valid encrypted checksum which is accepted by the destination control device. The software of the unauthorized person is thus not marked as “valid” and is not executed.

The invention thus provides the following advantages:
Due to the parallel flash-programming of comparable control devices such as, for example, sensor control devices, a gain in speed is achieved in flash programming.
Since the flash programming data are only sent once simultaneously to all control devices, faster flashing is provided in comparison with serial flash programming and, in addition, the data volume to be transmitted is reduced in flash programming.
Using encrypted checksums secures the flashing process and prevents infiltration of their own program code by unauthorized persons.
Proven and widely used encryption algorithms from the field of asymmetric encryption (public key encryption) are used.
The intensity of encryption can be selected which is particularly advantageous in adapting the computational complexity required for the encryption to the existing resources.

Advantageous developments of the invention are specified in the subclaims and described in the description.

### DRAWINGS

Exemplary embodiments of the invention are explained in greater detail by means of the drawings and the description following, in which:

FIG. 1 shows a diagrammatic illustration of a battery management system,

FIG. 2 shows an illustration of sequential flash programming with preceding individual challenge-response method according to the prior art, and

FIG. 3 shows a diagrammatic illustration of exemplary flash programming by broadcast communication.

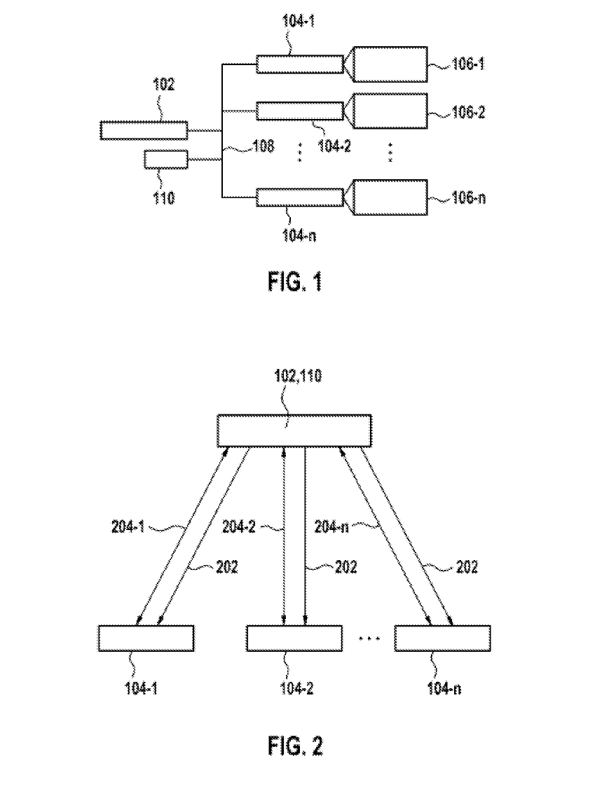

### EMBODIMENTS OF THE INVENTION

In an exemplary embodiment of the invention, analogously to the seed & key process,
a seed—in this case the public key—is transmitted and
a key calculated and transmitted which, in the exemplary embodiment, comprises at least the checksum, encrypted with the seed, of the data used for programming.

In this context, the invention is not restricted to this special exemplary embodiment. Instead, other authentication methods can also be used in the invention, for example particularly any asymmetric encryption. Although, in addition, the invention is described with the example of a battery management system having a central control device and a multiplicity of sensor control devices, the invention comprises any parallel secure programming of data processing means as long as the programming method implements only all features of in each case the independent claims.

Firstly, the method for programming control devices is to be described in principle using the example of programming a destination control device by a control device or a tester, respectively.

The destination control device to be programmed uses a fixed private and a fixed public key. The public key is requested by the programming control device/tester and then transferred from the destination control device to be programmed to the programming control device/tester. The programming control device calculates a checksum over the software to be flashed and encrypts this checksum with the public key of the destination control device. All known encryption methods from the environment of public key encryption can be used for this purpose. Subsequently, the software to be flashed is transferred together with the encrypted checksum to the destination control device. With the aid of the private key, the destination control device decrypts the checksum and compares the checksum with the checksum calculated by itself via the received software data. If the two checksums match, the software is marked as “valid” on the destination control device and is executed. Otherwise, the execution is prevented.

In an exemplary embodiment of the invention, a number of destination control devices 104-1, 104-2, . . . , 104-n (for example a number of n destination control devices 104-1, 104-2, . . . , 104-n), for example a number of similar sensor control devices, are co-ordinated, particularly programmed, from a central control device 102, for example a battery control device, or from a tester 110. The sensor control devices can detect, for example, measurement data such as temperature, voltage or the like of battery cells 106-1, 106-2, . . . , 106-n.

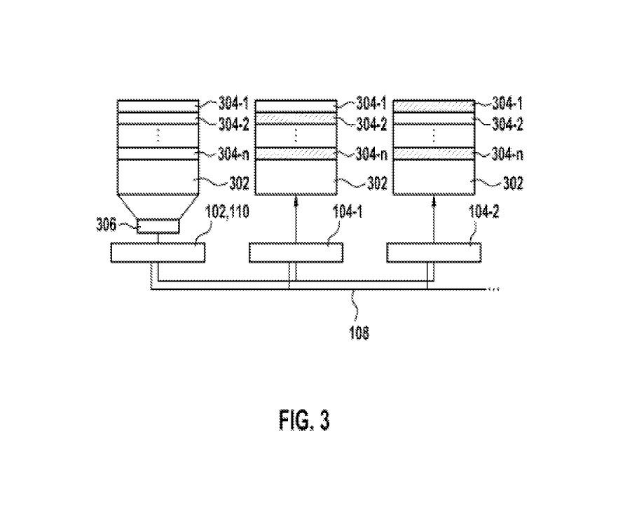

Each of the destination control devices 104-1, 104-2, . . . , 104-n to be programmed has a fixed private and public key. The public keys are requested by the programming central control device 102/tester 110 and then transferred by the destination control devices 104-1, 104-2, . . . , 104-n to be programmed to the central control device 102 or the tester 110, respectively. The programming central control device 102 calculates a checksum over the software 302 to be flashed and encrypts this checksum in each case with the public keys of the destination control devices 104-1, 104-2, . . . , 104-n. This results in n encrypted checksums 304-1, 304-2, . . . , 304-n. The programming central control device 102 or the tester 110, respectively, transfers the programming data 306, that is to say the software 302 to be flashed, together with the n encrypted checksums 304-1, 304-2, . . . , 304-n to all destination control devices 104-1, 104-2, . . . , 104-n to be programmed simultaneously in one data stream (compare FIG. 3). Each destination control device 104-1, 104-2, . . . , 104-n decrypts the checksum intended for it with the private key and compares this checksum with the checksum calculated by itself via the software 302. (The encrypted checksums which are not relevant to the respective destination control device are identified by shading in FIG. 3). If both checksums match, the software is marked as “valid” on the destination control device and executed. Otherwise, the execution is prevented. After the flash programming process, it is checked preferably individually whether the flash programming was successful in all destination control devices 104-1, 104-2, . . . , 104-n.

In a further exemplary embodiment, an accelerated method for flash programming is provided. If the same central control device 102 is always used for the programming as is the case, for example, in battery management systems with a main control device and many sensor control devices, the central control device 102 is programmed during the first startup. It requests their public keys from all subordinate destination control devices 104-1, 104-2, . . . , 104-n and stores these permanently in its own flash memory. This dispenses with the exchange of public keys before each flash process. If a subordinate destination control device 104-(i=1, 2, . . . , n) is replaced, which occurs rarely in battery systems, and has another public key, decrypting of the checksum with the associated private key will fail. The subordinate destination control device 104-i (i=1, 2, . . . , n) reports this failure to the central programming control device 102 which then requests (“programs”) the public key again.

To program the destination control devices 104-1, 104-2, . . . , 104-n, the central control device 102 or the tester 110, respectively, transfers the software 302 to be flashed, together with the n encrypted checksums 304-1, 304-2, . . . , 304-n, to all n destination control devices 104-1, 104-2, . . . , 104-n to be programmed simultaneously in one data stream (compare FIG. 3). Each destination control device 104-1, 104-2, . . . , 104-n decrypts the checksum intended for it by means of the private key and compares this checksum with the checksum calculated by itself via the software 302. If the two checksums match, the software is marked as “valid” on the destination control device and executed. Otherwise, the execution is prevented.

With respect to the conventional methods, the invention is distinguished in particular by the fact that the communication from the central control device 102 to the subordinate destination control devices 104-1, 104-2, . . . , 104-n takes place in the broadcast method. Thus, an individual data stream is necessary for each individual destination control device 104-1, 104-2, . . . , 104-n. The programming control device 102 transmits all encrypted checksums 304-1, 304-2, . . . , 304-n and the software 302 to be flashed by broadcasting to all destination control devices 104-1, 104-2, . . . , 104-n which only decrypt the checksum intended for them. Sending by broadcasting simplifies the communication considerably since it is not necessary to negotiate individually with each destination control device 104-1, 104-2, . . . , 104-n.

The invention thus provides a method in which the data for the programming (flash data) are transmitted with a single data stream from the main control device to all subordinate control devices and it is ensured at the same time that no unauthorized person obtains access to the flash memory of a control device in order to possibly infiltrate modified software code there.

Due to the parallel programming, the flash process of the subordinate control devices is accelerated essentially by the factor “number of control devices to be flashed” in comparison with sequential flashing of the control devices.

The method according to the invention is based on the method of asymmetric encryption with public keys (public key encryption) in which a subscriber encrypts a message with a public (known) key which can only be decrypted by a receiver by means of its secret (private) key.

In its embodiment, the invention is not restricted to the preferred exemplary embodiments specified above. Instead, a number of variants is conceivable which uses the method according to the invention, the battery according to the invention and the motor vehicle according to the invention also in the case of implementations of basically different type.

1. A programming method comprising:
programming at least two second data processing modules using a first data processing module;
providing first authentication information messages to the first data processing module, wherein each of the first authentication information messages is generated from each of at least two second data processing modules;
generating second authentication information messages, wherein each of the second authentication information messages is generated from each of the first authentication information messages;
transmitting the second authentication information messages to the at least two second data processing modules, wherein the second authentication information messages are transmitted jointly from the first data processing module using one-time sending to the at least two second data processing modules;
verifying each of the second authentication information messages using each of the at least two second data processing modules; and
programming the at least two second data processing modules after verifying each of the second authentication information messages.

2. The programming method as claimed in claim 1, wherein data for programming the at least two second data processing modules are transmitted together with the second authentication information messages using the one-time sending.

3. The programming method as claimed in claim 1, wherein the first authentication information messages transmitted to the first data processing module are used for a multiplicity of later programming of the at least two second data processing modules.

4. The programming method as claimed in claim 1, wherein at least a first part of the second authentication information messages is generated by encryption of a first identifier of programming data.

5. The programming method as claimed in claim 4, wherein the first authentication information messages differ for at least a second part of the at least two second data processing modules and the programming data are encrypted with the different first authentication information messages.

6. The programming method as claimed in claim 1, wherein at least a third part of the at least two second data processing modules:
receives programming data, a second identifier of the programming data, and a third identifier of the programming data, wherein the second identifier is encrypted with the first authentication information message for the second identifier and the third identifier is encrypted with the first authentication information messages for identifiers of the at least two second data processing modules and
programs the corresponding second data processing modules after the verification of the second identifier.

7. The programming method as claimed in claim 1, wherein the at least two second data processing modules are similar data processing modules.

8. The programming method as claimed in claim 1, wherein at least one of the first data processing module is a control device of a battery system and the at least two second data processing modules are control devices for sensors for detecting measurement data of battery cells.

9. A battery comprising:
an arrangement, wherein the arrangement comprises:
a first data processing module; and
at least two second data processing modules, wherein the arrangement is configured to:
program the at least two second data processing modules using the first data processing module
provide first authentication information messages to the first data processing module, wherein each of the first authentication information messages is generated from each of at least two second data processing modules;
generate second authentication information messages, wherein each of the second authentication information messages is generated from each of the first authentication information messages;
transmit the second authentication information messages to the at least two second data processing modules, wherein the second authentication information messages are transmitted jointly from the first data processing module using one-time sending to the at least two second data processing modules;
verify each of the second authentication information messages using each of the at least two second data processing modules; and
program the at least two second data processing modules after verifying each of the second authentication information messages.

10. The battery of claim 9, wherein the battery is comprised by motor vehicle, wherein the motor vehicle further comprises:
an electric drive motor for driving the motor vehicle, wherein the battery is connected to the electric drive motor.
